(19) United States
(12) Patent Application Publication
(10) Pub. No.: US 2025/0115747 A1
(43) Pub. Date: Apr. 10, 2025

(54) RUBBER COMPOSITION WITH SUPERIOR GRIP AND IMPROVED HYSTERESIS COMPOSITION

(71) Applicant: APOLLO TYRES GLOBAL R&D B.V., Enschede (NL)

(72) Inventors: Vikram SINGH, Enschede (NL); Tharik MOHAMED, Enschede (NL); Louis REUVEKAMP, Enschede (NL)

(73) Assignee: APOLLO TYRES GLOBAL R&D B.V., Enschede (NL)

(21) Appl. No.: 18/833,892

(22) PCT Filed: Jan. 25, 2023
(86) PCT No.: PCT/EP2023/051810

§ 371 Date: Jul. 27, 2024

(30) Foreign Application Priority Data
Jan. 27, 2022 (LU) 102904

(51) Int. Cl. C08L 15/00; B60C 1/00; B60C 11/00; C08K 3/36

(52) U.S. Cl. CPC C08L 15/00; B60C 1/0016; B60C 11/0008; C08K 3/36; B60C 2011/0025; C08K 2201/006; C08L 2312/08

(57) ABSTRACT

A cross-linkable rubber composition for a tyre tread, the cross-linkable rubber composition comprising, per hundred parts by weight of rubber (phr) a solution polymerized styrene-butadiene rubber (SSBR) comprising an alkoxysilane group and a primary amino group; ≥45 phr of at least one filler; and ≥1 phr of a resin; characterised in that the composition comprises ≥90 phr to ≤100 phr of the SSBR, wherein the SSBR has a styrene content of 20% to 35% and a vinyl content of 48% to 60% (as determined by nuclear magnetic resonance (NMR) spectroscopy) and a glass transition temperature Tg (determined by differential scanning calorimetry (DSC) according to ISO 22768) between −23 #C to −30 #C.

The present invention relates to a cross-linkable rubber composition, a cross-linked rubber composition obtained by cross-linking such a rubber composition, a method of preparing a tyre and a tyre.

Tyres can be optimized on several properties. For tyre application, wet traction and rolling resistance are particularly important. Wet traction is critical for safety of driver and passengers when the world moves towards autonomous or self-driven vehicles. Rolling resistance is important for reduction of fuel consumption. Wet grip is an important factor in the design of tire rubber, especially for the tire tread rubber, which is in direct contact with the ground, however, it is also true that this performance is difficult to improve due to the inverse correlation to rolling resistance. Styrene-butadiene rubbers, organic filler, and resins contribute on the improvement of wet grip while usually compromising on the hysteresis i.e. rolling resistance. It is a challenge to improve wet grip performance while keeping the rolling resistance at the same level.

WO2019141667 discloses a cross-linkable rubber composition, the cross-linkable rubber composition comprising, per hundred parts by weight of rubber (phr) more than 25 phr of a first rubber, the first rubber being a solution polymerized styrene-butadiene rubber (SSBR) comprising an alkoxysilane group and a primary amino group; more than 40 phr of a second rubber; and more than 1 phr of an aliphatic or aromatic resin; characterized in that the first rubber has a glass transition temperature Tg between −30° C. to 0° C., the second rubber has a glass transition temperature Tg of between −110° C. to −60° C. and the resin has a glass transition temperature Tg of more than 30° C.

EP2749404 discloses cross-linkable compositions comprising 60 phr of SSBR HPR355 containing alkoxysilyl groups and primary amine groups, and having a Tg of −27° C., 40 phr of high-cis BR Buna CB25 having a Tg of −110° C., and 12 phr of aromatic vinyl polymer SYLVARES SA 85 characterized by a Tg of 39° C. It also discloses cross-linked compositions obtained by cross-linking said cross-linkable compositions, and tyres comprising said cross-linked compositions.

US2012/029114 discloses a pneumatic rubber tyre comprising a rubber composition comprising 50-80 phr of a SSBR functionalized with an alkoxysilane group and an amino group, 5-40 phr of cis 1,4-polyisoprene rubber having a Tg in a range of −65 to −70° C., and 2-15 phr of styrene/alpha-styrene resin. As a preferred styrene/alpha-styrene resin, US2012/029114 discloses Resin 2336 from Eastman, which has a Tg of 38° C.

The present invention has the object to provide a composition having a superior wet grip performance and better rolling resistance.

This object is achieved by the cross-linkable rubber composition according to claim 1, the cross-linked rubber composition according to claim 8, the method according to claim 14, and a tyre according to claim 15. Advantageous embodiments are the subject of the dependent claims. They may be combined freely unless the context clearly indicates otherwise.

Accordingly, a cross-linkable rubber composition for a tyre tread is provided, the cross-linkable rubber composition comprising, per hundred parts by weight of rubber (phr):
a solution polymerized styrene-butadiene rubber (SSBR) comprising an alkoxysilane group
and a primary amino group;
≥45 phr of at least one filler; and
≥1 phr of a resin;
   wherein the composition comprises ≥90 phr to ≤100 phr of the SSBR, wherein the SSBR has a styrene content of 20 wt-% to 35 wt-% and a vinyl content of 48 wt-% to 60 wt-% (as determined by nuclear magnetic resonance (NMR) spectroscopy) and a glass transition temperature Tg (determined by differential scanning calorimetry (DSC) according to ISO 22768) between −23° C. to −30° C.

It has surprisingly been found that a combination of 90 to 100 phr of a single SSBR comprising an alkoxysilane group and a primary amino group having a styrene content of 20% to 35% and a vinyl content of 48% to 60% and a glass transition temperature Tg between −23° C. and −30° C. in combination with a reinforcing filler above 45 phr results in a rubber composition having a superior grip under wet conditions and enhanced hysteresis for lower tyre rolling resistance. Superior wet grip will result in a lowering of the braking distance which will improve the safety under wet conditions. The composition can achieve a balanced damping for improved wet grip in combination with improved hysteresis to reduce the tyre rolling resistance.

In the context of this invention the unit “phr” denotes “per hundred parts by weight of rubber” as it is commonly understood in the art. It is further understood that in formulations discussed in connection with the present invention the phr amount of all rubber components adds up to 100. The phr data (parts per hundred parts of rubber by weight) used in this specification are the conventional quantitative data used for mixture formulations in the rubber industry. The amount added in parts by weight of the individual substances in this specification is based on 100 parts by weight of the total mass of all of the solid rubbers present in the mixture.

The composition may comprise ≥0 phr to ≤10 phr of a diene rubber wherein the diene rubber may be selected from a group of a natural rubber (NR) or a butadiene rubber (BR) or a combination thereof. Preferably, the diene rubber is a natural rubber (NR).

In embodiments of the rubber composition, the composition comprises 100 phr of the SSBR. In embodiments of the rubber composition, the solution polymerized styrene-butadiene rubber has a styrene content in a range of 25 wt-% to 35 wt-% and a vinyl content in a range of 56 wt-% to 60 wt-% and a glass transition temperature Tg between −23° C. and −30° C. If not specifically denoted otherwise, given % are weight-%. Weight percent, weight-% or wt-%, are synonyms and are calculated on the basis of a total weight of 100 weight % of the respective object such as unit content, if not otherwise stated.

In embodiments of the rubber composition, the SSBR has a styrene content of 27.5 wt-% and a vinyl content of 59 wt-% and a Tg of −28° C.

The styrene-butadiene rubber is functionalised with an alkoxysilane group and a primary amino group. The alkoxysilyl group may be selected from methoxysilyl or ethoxysilyl. SSBR comprising an alkoxysilane group and a primary amino group having a styrene content of 25 wt-% to 35 wt-% and a vinyl content of 56 wt-% to 60 wt-% and a Tg between −23° C. and −30° C. is commercially available, for example HPR850 available from JSR.

The rubber composition further comprises a filler, particularly a reinforcing filler. The reinforcing filler may be selected from black filler or white filler or a combination thereof. A preferred while filler in the rubber industry is precipitated silica. A preferred black filler in the rubber industry is carbon black. In embodiments of the rubber composition, the filler is selected from carbon black or silica or a combination thereof. The total amount of filler in the rubber composition is preferably ≥55 phr to ≤140 phr. Preferably, the filler comprises a combination of silica and carbon black. Preferably, the composition comprises more silica compared to carbon black. The amount of silica in the composition may be in a range of ≥50 phr to ≤140 phr. The amount of carbon black in the composition may be in a range of ≥2 phr to ≤10 phr. In embodiments, the filler comprises a combination of silica and carbon black, wherein the ratio of carbon black to silica is in a range of 1:10 to 1:25. It is assumed that such as ratio of white to black filler will influence compound stiffness improving handling performance, and additionally will improve wear and with optimum wet performance.

In embodiments of the rubber composition, the silica has a surface area above 65 m²/g (according to ASTM D 2414).

The rubber composition comprises a resin. The addition of thermoplastic resins to a tread rubber composition can increase the wet grip of the cured tyre. In embodiments of the rubber composition, the composition comprises ≥3 phr to ≤45 phr of the resin, preferably ≥5 phr to ≤35 phr of the resin, more preferably ≥7 phr to ≤30 phr of the resin. The resin may be selected from the group of terpene-based resins, alpha-methyl styrene (AMS) resins, coumarone indene resins, an aliphatic hydrocarbon resin having a hydrocarbon chain formed from C5 fractions based on piperylene (C5 resin), an aliphatic hydrocarbon resin having a hydrocarbon chain formed from C9 fractions based on piperylene (C9 resin) and a combination thereof.

The cross-linkable rubber composition can also comprise one or more coupling agents. Suitable coupling agents comprise silane compounds. Particularly suitable silane compounds comprise di- and tetrasulphides. Preferably, the rubber composition comprises at least one coupling agent selected from the group of TESPD (bis-triethoxysilyl propyldisulfidosilane), TESPT (bis-triethoxysilyl propyltetrasulfidosilane), mercapto-silane or combinations thereof. The rubber composition may comprise the one or more coupling agents in a range from ≥5 phr to ≤15 phr.

Another aspect of the present invention is a cross-linked rubber composition obtained by cross-linking the rubber composition according to the invention. The cross-linkable rubber composition according to the invention comprises cross-linkable groups in the individual rubber components. They may be cross-linked (cured, vulcanised) by methods known to a skilled person in the rubber technology field. The cross-linkable rubber compositions may be sulfur-vulcanisable and/or peroxide-vulcanisable. Other vulcanization systems may also be used. If desired, additives can be added. Examples of usual additives are stabilizers, antioxidants, lubricants, fillers, dyes, pigments, flame retardants, conductive fibres and reinforcing fibres.

In an embodiment, the cross-linked rubber composition has a G″ at 0° C. (measured by dynamic mechanical analysis (DMA) as per ISO 4664-1) ranging from ≥14 to ≤60 MPa.

In another embodiment, the cross-linked rubber composition has a rebound value at 23° C. (as per ISO 4662) ranging from ≥6% to ≤20%.

In another embodiment, the cross-linked rubber composition has a tan delta value at 0° C. (determined from dynamic mechanical analysis (DMA) measurements according to ISO 4664-1, frequency 10 Hz, 0.1% dynamic strain) ranging from ≥0.75 to ≤1.3.

In another embodiment, the cross-linked rubber composition has a rebound value at 70° C. (as per ISO 4662) ranging from ≥44% to ≤73%.

In another embodiment, the cross-linked rubber composition has a tan delta value at 70° C. (determined from DMA measurements according to ISO 4664-1, frequency 10 Hz, 6% dynamic strain) ranging from ≥0.06 to ≤0.21.

The present invention also relates to a method of preparing a tyre, comprising the steps of:
providing a tyre assembly comprising a rubber composition according to the invention; and
cross-linking at least the rubber composition according to the invention in the tyre assembly.

The present invention also encompasses a tyre comprising a tyre tread, wherein the tyre tread comprises a cross-linked rubber composition according to the invention.

The present invention will be further described with reference to the following examples without wishing to be limited by them.

### Methods:

Rebound: Rebound measurements were performed for cured samples on a Zwick/Roell 5109 Rebound Resilience Tester according to the standardized ISO4662 method at 23° C. and 70° C.

Temperature sweep by DMA: Dynamic mechanical analysis (DMA) was performed for cured samples by Metravib DMA+450 in double shear mode. DMA was performed by temperature sweep at constant frequency 10 Hz with 6% strain in a temperature range of 25° C. to 80° C. DMA was also performed by temperature sweep at constant frequency 10 Hz with 1% strain in a temperature range of −80° C. to 25° C.

General procedure for preparing cross-linked rubber compositions: cross-linkable rubber compositions were prepared as described in the examples and cross-linked.

### EXAMPLE 1

Examples use a recipe for a reference tread compound (Ref) based on diene polymer and reinforcing fillers, a coupling agent and a thermoplastic resin, and experimental tread compounds according to the invention (Exp).

TABLE 1
Rubber components of experimental compositions and
reference compositions (Ref.):

| | Ref. 1 | Exp. 1.1 | Exp. 1.2 | Exp. 1.3 |
|---|---|---|---|---|
| Component: | Amount | Amount | Amount | Amount |
| | (phr) | (phr) | (phr) | (phr) |
| NR | 20.00 | — | — | — |
| SSBR 1 | 80.00 | — | — | — |
| SSBR 2 | — | 100.00 | 100.00 | 100.00 |
| Carbon Black | 5.50 | 5.00 | 5.00 | 3.00 |
| Silica | 70.00 | 65.00 | 60.00 | 55.00 |
| Coupling agent | 9.30 | 6.50 | 6.00 | 5.50 |
| Resin 1 | 10.00 | 10.00 | 10.00 | — |
| Resin 2 | — | 5.80 | — | 7.00 |

The NR rubber used was TSR 20 from Olam International Limited.
The SSBR1 rubber used was non-oil extended functionalized solution polymerized styrene-butadiene rubber Sprintan SLR 4602 with 21% bound styrene, 49% vinyl and a Tg of −23° C. from Trinseo.
The SSBR2 rubber used was non-oil extended, functionalized with an alkoxysilane group and a primary amino group, solution polymerized styrene-butadiene rubber HPR850 with 27.5% bound styrene, 59% vinyl and a Tg of −28° C. from JSR.
The Carbon Black used was N339 from Orion Engineered Carbons.
The silica used in the composition was high dispersed (HD) silica, Hi Sil IZ 160GD from PPG Industries.
The Resin 1 was terpene phenolic resin Sylvatraxx 4202 from Kraton.
The Resin 2 was coumarone indene Novares C30 resin from Rutgers.
The coupling agent was mercapto based silane Si363 from Evonik Industries

In addition to the components listed in the table, all samples contained process oil, and a sulphur-based vulcanization package.

The rubber components were mixed with the further components as given in table 1 and vulcanised.

The experimental compounds were measured for rebound and DMA as performance predictors. The vulcanised rubber samples were used for DMA measurements according to ISO 4664-1, with a frequency of 10 Hz, a dynamic strain of 0.1% and a temperature range from −80° C. to +25° C. Dynamic mechanical analysis measurements were performed on a DMA equipment of the type Metravib DMA+450 in double shear mode. Shore A (ShA) hardness was tested according to ISO 7619-1. The following table 2 shows the results obtained from the cured compositions of the table 1.

TABLE 2
results

| | | Ref. 1 | Exp. 1.1 | Exp. 1.2 | Exp. 1.3 |
|---|---|---|---|---|---|
| Rebound (23° C.) | % | 22.90 | 13.40 | 12.80 | 20.20 |
| G″ (0° C.) | | 6.89 | 41.08 | 40.56 | 14.81 |
| Tanδ (0° C.) | | 0.55 | 1.24 | 1.21 | 1.27 |
| Rebound (70° C.) | % | 62.90 | 72.10 | 71.20 | 74.50 |
| Tanδ (70° C.) | | 0.12 | 0.08 | 0.08 | 0.06 |

It is seen from the results in table 2 that rebound decreased compared to the reference composition. Rebound at 23° C. is an indicator of grip under wet conditions; lower values indicate improvement on wet grip. DMA G″ at 0° C. indicates loss of energy; higher values (energy loss) indicate improvement in grip under wet conditions. DMA Tan δ at 0° C. is an indicator of grip under wet conditions; higher values indicate improvement on wet grip. Rebound at 70° C. is an indicator of hysteresis of material; and higher values indicate improvement on tyre rolling resistance. DMA Tan δ at 70° C. is an indicator of hysteresis of material; and lower values indicate improvement on tyre rolling resistance. From the results of table 2 it was surprisingly observed that the experimental compositions 1.1, 1.2 and 1.3 have better grip under wet condition with extremely better rolling resistance indicated by Rebound and DMA Tan δ values compared to the reference.

### EXAMPLE 2

Examples use a recipe for a reference tread compound (Ref) based on diene polymer and reinforcing fillers, a coupling agent and a thermoplastic resin, and experimental tread compounds according to the invention (Exp).

TABLE 3
Rubber components of experimental compositions and
reference composition (Ref.):

| | Ref. 2 | Exp. 2.1 | Exp. 2.2 | Exp. 2.3 |
|---|---|---|---|---|
| Component: | Amount | Amount | Amount | Amount |
| | (phr) | (phr) | (phr) | (phr) |
| BR | 15.00 | — | — | — |
| SSBR 2 | — | 100.00 | 100.00 | 100.00 |
| SSBR 3 | 40.00 | — | — | — |
| SSBR 4 | 5.00 | — | — | — |
| SSBR 5 | 40.00 | — | — | — |
| Carbon Black | 8.00 | 5.00 | 5.00 | 5.00 |
| Silica | 100.00 | 130.00 | 130.00 | 75.00 |
| Coupling agent | 11.20 | 13.00 | 11.70 | 7.50 |
| Resin 1 | 4.00 | 30.00 | 15.00 | 8.00 |
| Resin 2 | — | — | 15.00 | 7.00 |
| Process Oil | 4.00 | 30.00 | 30.00 | — |

The BR rubber used was Nickel catalyzed butadiene rubber KBR-01 from KKPC.
The SSBR2 rubber used was solution polymerized styrene-butadiene rubber HPR850 functionalized with an alkoxysilane group and a primary amino group, with 27.5% bound styrene, 59% vinyl and a Tg of −28° C. from JSR.
The SSBR 3 rubber used was solution polymerized styrene-butadiene rubber Europrene SOL RC3743 from Versalis.
The SSBR 4 rubber used was solution polymerized styrene-butadiene rubber SE SLR 4601 from Trinseo.
The SSBR 5 rubber used was solution polymerized styrene-butadiene rubber SE SLR 4630 from Trinseo.
The Carbon Black used was N134 or N339 from Orion Engineered Carbons.
The silica used in the composition was HD silica, Hi Sil IZ 160GD from PPG Industries.
The Resin 1 was terpene phenolic resin Sylvatraxx 4202 from Kraton.
The Resin 2 was Impera P1503 from Kraton.
The coupling agent was mercapto based silane Si363 from Evonik Industries.
The process oil was Treated Distillate Aromatic Extract (TDAE) from BP.

In addition to the components listed in the table, all samples contained a sulphur-based vulcanization package.

The rubber components were mixed with the further components as given in table 3 and vulcanised.

The vulcanised rubber samples were used for DMA measurements according to ISO 4664-1, with a frequency of 10 Hz, a dynamic strain of 0.1% and a temperature range from −80° C. to +25° C. Dynamic mechanical analysis measurements were performed on a DMA equipment of the type Metravib DMA+450 in double shear mode. Shore A (ShA) hardness was tested according to ISO 7619-1. The following table 4 shows the results obtained from the cured compositions of the table 1.

TABLE 4
results

| | | Ref. 2 | Exp. 2.1 | Exp. 2.2 | Exp. 2.3 |
|---|---|---|---|---|---|
| Rebound (23° C.) | % | 17.30 | 8.30 | 7.60 | 11.30 |
| G″ (0° C.) | | 13.81 | 41.32 | 59.26 | 42.20 |
| Tanδ (0°C) | | 0.28 | 1.04 | 0.75 | 1.06 |
| Rebound (70° C.) | % | 44.60 | 54.30 | 44.30 | 69.10 |
| Tanδ (70° C.) | | 0.20 | 0.12 | 0.21 | 0.09 |

It is seen from the results in table 4 that the results for rebound at 23° C. were lower for the experimental compositions which is an indicator of improvement on wet grip. From the results of table 4 it was also observed that the experimental compositions 2.1, 2.2 and 2.3 have extremely better grip under wet condition with similar or better rolling resistance indicated by Rebound and DMA Tan δ values compared to the reference composition 2.

### EXAMPLE 3

Examples use a recipe for a reference tread compound (Ref) based on diene polymer and reinforcing fillers, a coupling agent and a thermoplastic resin, and experimental tread compounds according to the invention (Exp).

TABLE 5
Rubber components of experimental compositions and
reference composition (Ref.):

| | Ref. 3 | Ref. 3.1 | Exp. 3.2 | Exp. 3.3 | Exp. 3.4 |
|---|---|---|---|---|---|
| Component: | Amount | Amount | Amount | Amount | Amount |
| | (phr) | (phr) | (phr) | (phr) | (phr) |
| NR | 20.00 | 15.00 | 10.00 | 5.00 | — |
| SSBR 1 | 80.00 | 85.00 | 90.00 | 95.00 | 100.00 |
| Carbon Black | 5.50 | 5.50 | 5.50 | 5.50 | 5.50 |
| Silica | 70.00 | 70.00 | 70.00 | 70.00 | 70.00 |
| Coupling agent | 9.30 | 9.30 | 9.30 | 9.30 | 9.30 |
| Resin 1 | 10.00 | 10.00 | 10.00 | 10.00 | 10.00 |

The NR rubber used was TSR 20 from Olam International Limited.
The SSBR1 rubber used was non-oil extended functionalized solution polymerized styrene-butadiene
rubber Sprintan SLR 4602 with 21% bound styrene, 49% vinyl and a Tg of −23° C. from Trinseo.
The Carbon Black used was N339 from Orion Engineered Carbons.
The silica used in the composition was HD silica, Hi Sil IZ 160GD from PPG Industries.
The Resin 1 was terpene phenolic resin Sylvatraxx 4202 from Kraton.
The coupling agent was mercapto based silane Si363 from Evonik Industries

In addition to the components listed in the table, all samples contained process oil, and a sulphur-based vulcanization package. The rubber components were mixed with the further components as given in table 5 and vulcanised.

TABLE 6
results

| | | Ref. | Ref | Exp. | Exp. | Exp. |
|---|---|---|---|---|---|---|
| | | 3 | 3.1 | 3.2 | 3.3 | 3.4 |
| Rebound (23° C.) | % | 22.70 | 21.40 | 19.50 | 17.60 | 16.60 |
| G″ (0° C.) | | 6.89 | 16.69 | 19.95 | 18.98 | 25.46 |
| Tanδ (0° C.) | | 0.55 | 0.60 | 0.66 | 0.73 | 0.75 |
| Rebound (70° C.) | % | 62.90 | 61.40 | 60.60 | 60.80 | 59.70 |
| Tanδ (70° C.) | | 0.11 | 0.12 | 0.12 | 0.12 | 0.13 |

It is seen from the results in table 6 that the results for rebound at 23° C. were lower which is an indicator of improvement on wet grip. From the results of the table 6 it was clearly observed that when the amount of the SSBR decreases the rolling resistance deteriorates when the wet grip improves and vice versa. Thus, it is important to keep the amount of the SSBR above 90 phr in the composition.

In summary, the rubber compositions according to the invention achieved a superior grip under wet conditions which resulted in the lowering of the braking distance and enhanced (similar or better) hysteresis for lower tyre rolling resistance.

1. A cross-linkable rubber composition for a tyre tread, the cross-linkable rubber composition comprising, per hundred parts by weight of rubber (phr):
a solution polymerized styrene-butadiene rubber (SSBR) comprising an alkoxysilane group and a primary amino group;
≥45 phr of at least one filler; and
≥1 phr of a resin;
characterised in that the composition comprises ≥90 phr to ≤100 phr of the SSBR, wherein the SSBR has a styrene content of 20 wt-% to 35 wt-% and a vinyl content of 48 wt-% to 60 wt-% (as determined by nuclear magnetic resonance (NMR) spectroscopy) and a glass transition temperature Tg (determined by differential scanning calorimetry (DSC) according to ISO 22768) between −23° C. to −30° C.

2. The rubber composition according to claim 1, wherein the SSBR has a styrene content of 27.5 wt-% and a vinyl content of 59 wt-% and a Tg of −28° C.

3. The rubber composition according to wherein the composition comprises 100 phr of the SSBR.

4. The rubber composition according to claim 1, wherein the composition comprises ≥55 phr to ≤140 phr of a filler selected from carbon black, silica or a combination thereof.

5. The rubber composition according to claim 1, wherein the composition comprises ≥2 phr to ≤10 phr of carbon black and ≥50 phr to ≤130 phr of silica.

6. The rubber composition according to claim 1, wherein the silica has a surface area above 65 m²/g (according to ASTM D 2414).

7. The rubber composition according to claim 1, wherein the composition comprises ≥3 phr to ≤45 phr, preferably ≥5 phr to ≤35 phr, more preferably ≥7 phr to ≤30 phr, of the resin, preferably of a resin selected from the group of terpene-based resins, alpha-methyl styrene (AMS) resins, coumarone indene resins, C5 resins, and C9 resins.

8. A cross-linked rubber composition, characterized in that it is obtained by cross-linking a rubber composition according to claim 1.

9. The cross-linked rubber composition according to claim 8 with a G″ at 0° C. (measured by DMA as per ISO 4664-1) ranging from ≥14 to ≤60 MPa.

10. The cross-linked rubber composition according to claim 8 with a rebound value at 23° C. (as per ISO 4662) ranging from ≥6% to ≤20%.

11. The cross-linked rubber composition according to claim 8 with a tan delta value at 0° C. (determined from dynamic mechanical analysis (DMA) measurements according to ISO 4664-1, frequency 10 Hz, 0.1% dynamic strain) ranging from ≥0.75 to ≤1.3.

12. The cross-linked rubber composition according to claim 8 with a rebound value at 70° C. (as per ISO 4662) ranging from ≥44% to ≤73%.

13. The cross-linked rubber composition according to claim 8 with a tan delta value at 70° C. (determined from DMA measurements according to ISO 4664-1, frequency 10 Hz, 6% dynamic strain) ranging from ≥0.06 to ≤0.21.

14. A method of preparing a tyre, comprising the steps of:
providing a tyre assembly comprising a rubber composition comprising, per hundred parts by weight of rubber (phr):
a solution polymerized styrene-butadiene rubber (SSBR) comprising an alkoxysilane group and a primary amino group;
≥45 phr of at least one filler; and
≥1 phr of a resin;
characterised in that the composition comprises ≥90 phr to ≤100 phr of the SSBR, wherein the SSBR has a styrene content of 20 wt-% to 35 wt-% and a vinyl content of 48 wt-% to 60 wt-% (as determined by nuclear magnetic resonance (NMR) spectroscopy) and a glass transition temperature Tg (determined by differential scanning calorimetry (DSC) according to ISO 22768) between −23° C. to −30° C.;
cross-linking at least the rubber composition.

15. A tyre comprising a tyre tread for a light truck tyre, characterised in that the tyre tread comprises a cross-linked rubber composition according to claim 8.
